(19) United States
(12) Patent Application Publication
(10) Pub. No.: US 2013/0245804 A1
(43) Pub. Date: Sep. 19, 2013

(54) NETWORK BASED CALCULATIONS FOR PLANNING AND DECISION SUPPORT TASKS

(71) Applicants: Werner Sinzig, Nusslock (DE); Hartmur Koerner, Ladenburg (DE); Inga Wiele, Eppingen (DE)

(72) Inventors: Werner Sinzig, Nusslock (DE); Hartmur Koerner, Ladenburg (DE); Inga Wiele, Eppingen (DE)

(73) Assignee: SAP AG, Walldorf (DE)

(21) Appl. No.: 13/421,051

(22) Filed: Mar. 15, 2012

(51) Int. Cl. G06F 19/00

(52) U.S. Cl. 700/100

(57) ABSTRACT

Systems and methods to provide network based calculations for planning and decision support tasks are provided. In example embodiments, a trigger to perform a calculation directed to a single process is received. The single process comprises an end-to-end process that combines a plurality of applications. A planning function that models the single process is provided to an engine within memory. Based on the planning function, data from within the memory that receives the planning function is retrieved. The retrieved data is used in the calculation. The planning function and retrieved data are provided to a coupled library of algorithms for performing the calculation. The calculation is then performed within the library in the memory using the planning function and the retrieved data.

### FIELD

The present disclosure relates generally to business planning, and in a specific example embodiment, to network based calculations for planning and decision support tasks.

### BACKGROUND

Conventionally, managing planning and decision processes is a cumbersome process that may run across several applications. The different applications are not reconciled with each other by nature of the architecture in the system performing the applications. Typically, the processes include long-running batch processes that are run sequentially due to the distributed storage of master data and transactional data, and which may take several days to complete. This results in a need to perform many data transfers. Additionally, the processes only take into consideration data that is available in an enterprise resource planning (ERP) system. Because the processes are run in batches and each application has a specific data structure and user interface design, collaboration is not possible between different entities using different applications in a business nor is it possible to simulate alternative scenarios based on a change to one or more data points.

### BRIEF DESCRIPTION OF DRAWINGS

Various ones of the appended drawings merely illustrate example embodiments of the present invention and cannot be considered as limiting its scope.

FIG. 1 illustrates an environment in which example embodiments of the inventive subject matter may be practiced.

FIG. 2a is a block diagram illustrating one embodiment of a network based calculation system.

FIG. 2b is a block diagram illustrating an alternative embodiment of the network based calculation system.

FIG. 3 is a block diagram of a planning function engine.

FIG. 4 a flowchart of an example method for providing a network based calculation system.

FIG. 5 is a flowchart of an example method for performing a single process calculation using the network based calculation system.

FIG. 6 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Systems and methods for providing network based planning and decision support calculations are provided. In example embodiments, a trigger to perform a calculation based on an equation directed to a single process is received. The single process comprises an end-to-end process that combines a plurality of applications. A planning function that models the single process is provided to an engine within memory. Based on the planning function, data from within the memory that receives the planning function is retrieved. The retrieved data is used in the calculation. In some embodiments, the planning function and retrieved data are provided to a coupled library of algorithms for performing the calculation. The calculation is then performed within the library of the memory using the planning function and the retrieved data. The result of the calculation is stored back into the memory.

As such, example embodiments allow for online processing of calculations for planning and decision support. This, in turn, allows for simulations based on a change in any portion of the process. For example with respect to a cost management scenario, cost management is treated as an end-to-end cost management process that allows for simulating how expenses, purchase prices, product design, and production activities influence product cost. For example, if a salary is changed at a cost center, a simulation may be executed to determine an impact on a product cost based on the higher salary. In another example, if a price of raw material used in a product goes up, a scenario may be executed to see the impact on the product cost. The results may be provided to various individuals in the business/organization. For instance, a manager can see effects an increase in material cost has on product cost. In a further example, a manager in charge of efficiency in production can determine an impact of running machines faster (e.g., less time in a cost center to produce a unit) on the product cost. Furthermore, individual users can see what impact their work has on the final product (e.g., cost of final product). These are only some examples of forward calculations capable of being performed by example embodiments of the present inventive subject matter.

Backward calculations may also be performed by example embodiments. For example, assume a business wants to sell 100 units of a product. Given a particular product cost, performing backward calculations will provide material costs, machine resources, labor resources, or other costs. These forward and backward calculations may be performed as online transactions and the results can be provided back to various individuals (e.g., line managers, purchase managers, product managers, marketing) quickly. As a result, these individuals can see the impact of their departments' activities (e.g., change in material cost, change in efficiency program, change in design, or cost for training).

Example embodiments also allow for collaboration between these different individuals of an organization (e.g., business entity). Because example embodiments can provide simulations performed as a single end-to-end process in the network (e.g., on-line environment), these individuals may work together and immediately see the impact of a change on the final product. For example, if the price increases for raw material, the product will become more expensive. The business may want to adjust for this price increase by, for example, decreasing time needed in production (e.g., increasing efficiency or changing product design to use different raw material). The results may be provided back to different people in the organization including a line manager, purchase manager product manager, marketing, and so on to see what the impact will be on their activities. Thus, example embodiments allow for the running of these different simulations to help the business determine an optimal solution.

By using embodiments of the present invention, a single planning or decision support process is performed using a network based system. Accordingly, one or more of the methodologies discussed herein may obviate a need for separate batch processing of data by different applications, which may have the technical effect of reducing computing resources used by one or more devices within the system. Examples of such computing resources include, without limitation, processor cycles, network traffic, memory usage, storage space, and power consumption.

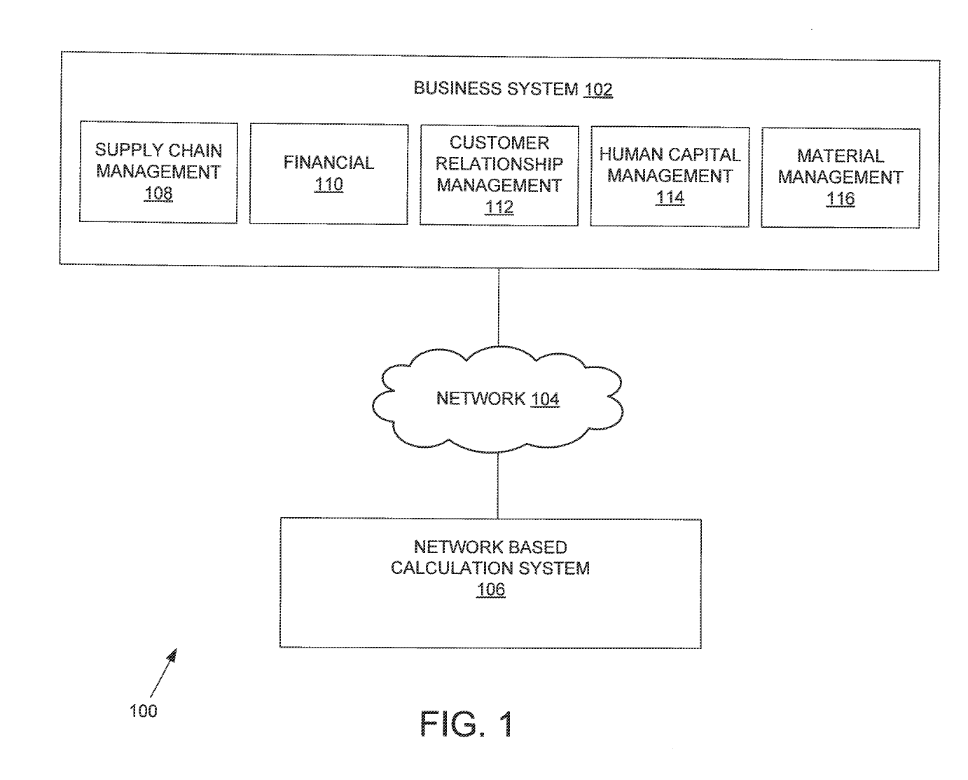

With reference to FIG. 1, an environment 100 in which example embodiments of the inventive subject matter may be practiced is shown. The environment 100 comprises a business system 102 communicatively coupled via a network 104 to a network based calculation system 106. The business system 102 may be located at a location of a business or customer and manages data specific to the business needs of the customer. For example, the business system 102 may comprise a customer enterprise resource planning (ERP) system. However, the business system 102 may comprise any logistical system which provides data to the network based calculation system 106.

In example embodiments, the business system 102 is linked via the network 104 with the network based calculation system 106 to allow the network based calculation system 106 to perform planning and decision support task calculations for the business system 102. The network 104 may comprise the Internet, a wireless network, a cellular network, a Wide Area Network (WAN), or any other type of network which allows for exchange of communications.

In example embodiments, the business system 102 may comprise a plurality of different departments or sub-systems that contribute data to the network based calculation system 106. The departments or sub-systems may comprise, for example, supply chain management 108, financial 110, customer relationship management 112, human capital management 114, and material management 116. These are merely examples and other departments and sub-systems may be provided in the business system 102.

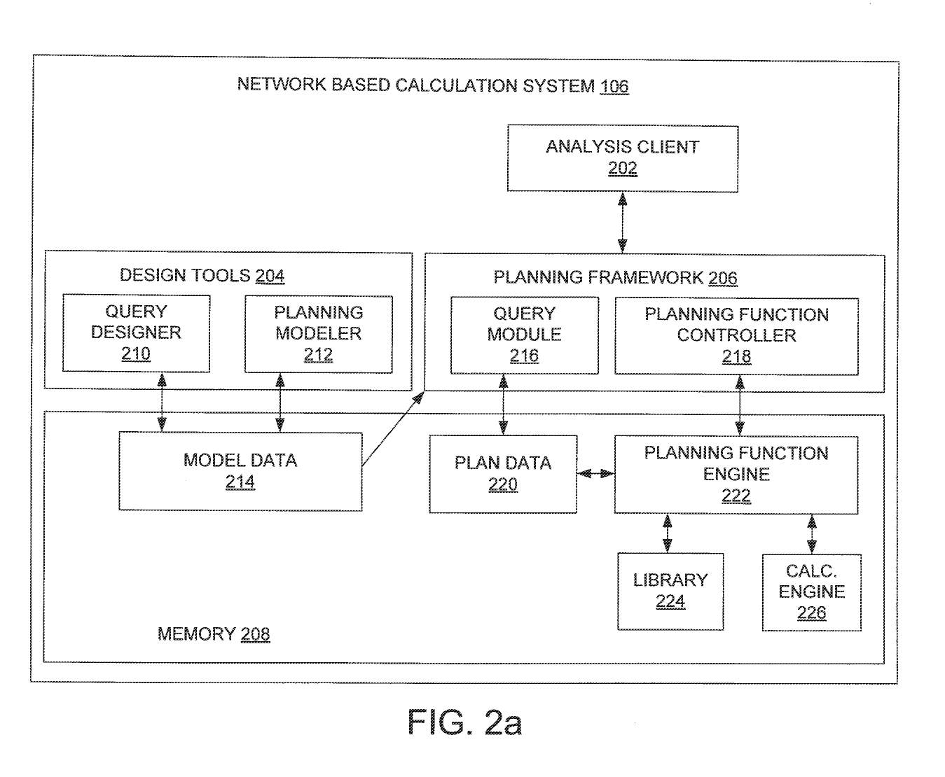

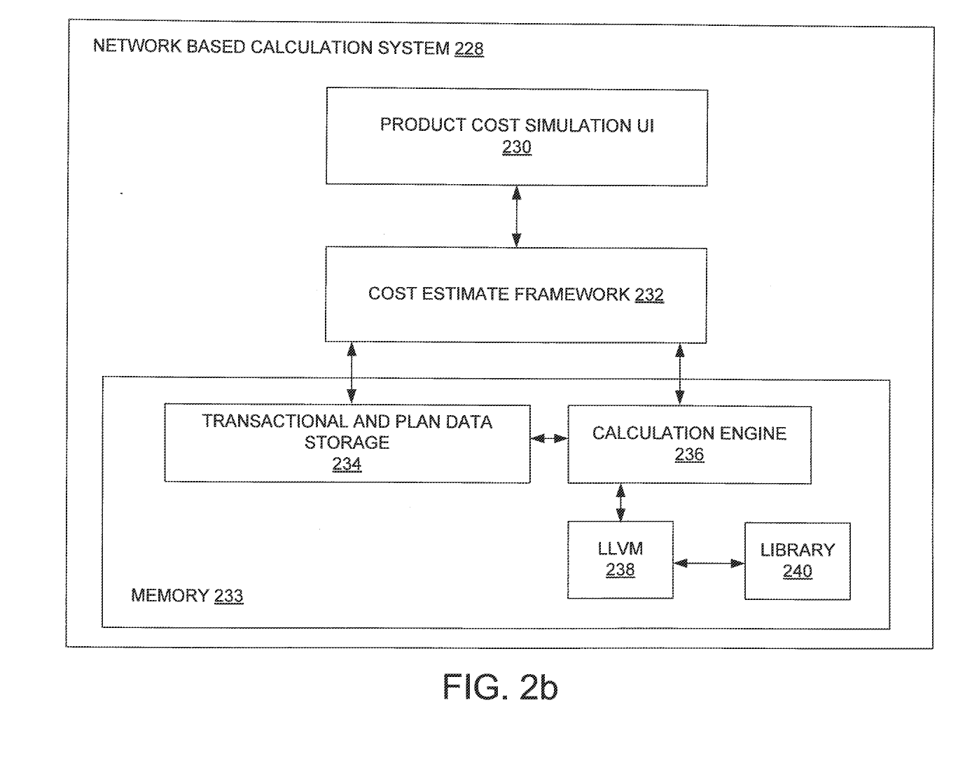

In one embodiment, the network based calculation system 106 may be part of an on-demand system which is hosted by a service provider. The on-demand system comprises one or more network applications that provide services and support to a customer (e.g., business) without the customer having to host the system on their premises. That is, the service provider hosts (e.g., offers, provides, implements, executes, or performs one or more operations of) the systems and the customer can assess functionalities online through a software-as-a-service (SaaS) model. The on-demand systems may include, for example, services and support for supply chain management, human resource management, customer relationship management (CRM), financial and accounting management, compliance management, supplier relationship management, or any other form of business management. The network based calculation system 106 will be discussed in more detail in connection with FIG. 2a below.

The environment 100 of FIG. 1 is merely an example and alternative embodiments may comprise any number of business systems 102 communicatively coupled to any number of network based calculation systems 106. Furthermore, components and functions of the business system 102 and the host financial system 106 may be combined, separated, or located elsewhere in the environment 100. For example, the network based calculation system 106 may be located at the business system 102. Additionally, while examples are discussed with respect to cost management processes, it is noted that example embodiments may be applied to any type of planning or decision support process (e.g., rough cut capacity planning, sourcing of critical components, distribution network planning).

FIG. 2a is a block diagram illustrating the network based calculation system 106 of FIG. 1 in further detail. The network based calculation system 106 may be implemented, for example, in a SAP Business Information Warehouse (BW) environment. In accordance with example embodiments, the network based calculation system 106 comprises an analysis client 202, design tools 204, a planning framework 206, and memory 208. The analysis client 202 provides a front end for the user to provide data to, and access data from, the memory 208. In one embodiment, the analysis client 202 provides a user interface for this exchange of data. The design tools 204 model the different processes from various applications and departments into a single process model and generate data queries to retrieve data for application to the single process model. Accordingly, the design tools 204 include a query designer 210 to generate the data queries to obtain data from the business system 102 in performing the calculations and a planning modeler 212 to generate the model.

In a cost management embodiment, the planning modeler 212 defines a “meta model” that defines entities (e.g., cost centers, products, activities) and their principal relationships (e.g., a product can consume an activity from a cost center whereby a formula may be activity value=routing coefficient*activity quantity*activity price). While the planning modeler 212 defines principal relationships, concrete relationships between cost centers, activities, cost drivers, processes, materials, semi-finished products, and finished products (e.g., product A needs five hours from cost center B) may be imported from the business system 102 or maintained manually through the analysis client 202. These concrete relationships may be modeled as networks formalized as systems of linear equations. As such, the meta model (that models inputs and outputs) may be translated into a system of linear equations by the planning modeler 212. By using linear equations, forward calculations (e.g., from cost center expenses and purchase prices to product cost) as well as backward calculations (e.g., from production volume to capacity load and to demand of semi-finished goods and material) can be executed. The linear equations may be solved by numeric algorithms. These numeric algorithms may be stored in a library (e.g., International Mathematics and Statistics Library—IMSL) as will be discussed in more detail below.

In one embodiment, the model is a cost management model. The cost management model may use the following variables:
bᵢⱼ Bill of Material: Number of units of product i needed to produce one unit of product j
aᵢⱼ Routing: Activity of the Cost Center i needed to produce one unit of product j
cᵢⱼ Activity Input from Cost Center i to Cost Center j
rᵢ Cost rate of Cost Center i
mcᵢ Cost of Goods Manufactured of product i per unit
ppᵢ Purchase Price of product i per unit
prᵢ Primary Costs of Cost Center i
lᵢ Load of Cost Center i
pᵢ Primary demand of product i
sᵢ Secondary demand of product i

In one example, the linear equation system for the cost management scenario can be set up as follows.

$$Manufacturing Costs$$

$${mc}_{i} = {\sum }_{j} {a}_{ji} {r}_{j} + {\sum }_{j} {b}_{ji} {mc}_{j} + {pp}_{i} \\ Input and Output of Cost Centers$$

$${pr}_{i} + {\sum }_{j} {c}_{ji} {r}_{j} = {r}_{i} ( {\sum }_{j} {c}_{ij} + {l}_{i} )$$

$$Demand$$

$${s}_{i} = {\sum }_{j} {b}_{ij} ( {p}_{j} + {s}_{j} )$$

$$Cost Center Load$$

$${l}_{i} = {\sum }_{j} {a}_{ij} ( {p}_{j} + {s}_{j} )$$

Depending on the scenario, sonic variables are given and some have to be calculated. The equation system then is brought to a format of

b=Ax

with given vector b and matrix A and vector x is to be calculated. For example, with given purchase prices, primary costs, routing, bill of material and capacity load, the equation to calculate the manufacturing costs and cost center rates can be written as

$${pp}_{i} = {mc}_{i} - {\sum }_{j} {b}_{ji} {mc}_{j} - {\sum }_{j} {a}_{ji} {r}_{j}$$

$${pr}_{i} = - {\sum }_{j} {c}_{ji} {r}_{j} + {r}_{i} ( {\sum }_{j} {c}_{ij} + {l}_{i} )$$

or in matrix notation

$$( \begin{matrix}pp \\ pr\end{matrix} ) = ( \begin{matrix}1 - {B}^{T} & - {A}^{T} \\ 0 & L\end{matrix} ) ( \begin{matrix}mc \\ r\end{matrix} )$$

$$with$$

$${L}_{ij} = {δ}_{ij} ( {\sum }_{k} {c}_{jk} + {l}_{j} ) - {c}_{ji}$$

$$and {δ}_{ij} = 1 for i = j and 0 for i \neq j .$$

As such, cost management may be formalized as a single application or process based on a unified data model. The above manufacturing cost equation illustrates one example of a type of linear equation that can be used by example embodiments. It is noted that other types of linear equations may be contemplated for use.

In the present example, the goal is to derive a single equation that operates on a database. As a result, the problem may be solved in a single process or equation instead of by several sequential steps as is performed in convention systems. The model including queries (e.g., how input screens on a user interface appear) and parameterizations of the planning functions are stored to memory 208 in a model data database 214.

The planning framework 206 extracts data for processing and provides the trigger to perform the processing. In example embodiments, the planning framework 206 comprises a query module 216 and a planning function controller 218. The query module 216 uses one or more queries from the model data database 214 to read data from a plan data store 220 (e.g., storing input data) and present it to the analysis client 202. The data in the plan data store 220 may include data extracted from the business system 102 that may be used in the calculations. The data presented to the analysis client 202 may be overridden by a user by, for example, using a user interface provided by the analysis client 202. Alternatively, the user may provide some of the inputs (e.g., when running a hypothetical simulation, the user may provide different values for the network based calculation system 106 to consider) directly into the user interface provided by the analysis client 202. For example, the user may change numbers on edges, add/delete relationships between nodes, add/delete nodes, or provide specific value inputs. The inputs from the user may be stored to the plan data database 220 located in the memory 208.

The calculation, itself, is a planning function that is not executed on an application server, but is executed directly on the data in a data store (e.g., the memory 208). Accordingly, the planning function controller 218 pushes the planning function (e.g., from the model data database 214) down to the memory 208 to be executed in a planning function engine 222 located in the memory 208. Because all the data needed to perform the calculation is stored in memory 208 and the planning functions are now pushed down into the memory 208, the network based calculation system 106 is able to perform the processing more efficiently and quickly.

The planning function engine 222 accesses planning functions (e.g., linear equations) from the model data database 214 via the planning function controller 218 and the input data from the plan data database 220 and executes the planning functions on the library 224 and the calculation engine 226. In example embodiments, the library 224 solves the linear equations of the planning functions by applying algorithms with the given parameterization to solve the linear equations. The library 224 may be a published library that is available for public use. In one embodiment, the library 224 comprises the IMSL, which is a commercial collection of (software) libraries of numerical analysis functionality or algorithms. Large systems of linear equations can be solved efficiently by applying these numerical algorithms. While the present embodiment shows the library 224 being located within the memory 208 and coupled to the planning function engine 222, alternative embodiments may have the library 224 located outside of the memory 208 but coupled thereto.

The calculation engine 226 executes other planning functions such as, for example, copying or simple (non-linear) formula calculations. The results are then returned to the planning function engine 222 and may be stored in the memory 208 (e.g., the plan data database 220). The results may also be displayed in a front end, for example, by the user interface provided by the analysis client 202 to the user.

The memory 208 comprises a complete in-memory database that comprises data (e.g., model/configuration data and transactional data) and algorithms (e.g., stored procedures). The model data database 214 represents the model/configuration data, while the plan data database 220 provides the transactional data. The planning function engine 222, the library 224, and the calculation engine 226 represent various algorithms which may be applied to the planning functions.

FIG. 2b is a block diagram illustrating an alternative network based calculation system 228. The network based calculation system 228 of FIG. 2b may be implemented, for example, in a SAP Business by Design environment, which may be a cloud based environment. While the components of the alternative network based calculation system 228 are different, the end results are the same as those determined for the embodiment of FIG. 2a. In accordance with example embodiments, the network based calculation system 228 comprises a product cost simulation user interface (UI) 230, a cost estimate framework 232, and memory 233. The product cost simulation UI 230 provides a front end for the user to provide data to, and access data from, the memory 233. In one embodiment, the product cost simulation UI 230 provides a user interface for this exchange of data.

The cost estimate framework 232 models the different processes from various applications and departments into a single process model and includes data queries to retrieve data for application to the single process model from a transactional and plan data storage 234 in the memory 233. Calculations may be performed in a calculation engine 236 in the memory 233.

In a cost management embodiment, the cost estimate framework 232 defines a “meta model” that defines entities (e.g., cost centers, products, activities) and their principal relationships (e.g., a product can consume an activity from a cost center whereby a formula may be activity value=routing coefficient*activity quantity*activity price). While the cost estimate framework 232 defines principal relationships, concrete relationships between cost centers, activities, cost drivers, processes, materials, semi-finished products, and finished products (e.g., product A needs five hours from cost center B) may be imported from the transactional and plan data storage 234. These concrete relationships may be modeled as networks formalized as systems of linear equations. As such, the meta model may be translated into a system of linear equations by the calculation engine 236. By using linear equations, forward calculations (e.g., from cost center expenses and purchase prices to product cost) as well as backward calculations (e.g., from production volume to capacity load and to demand of semi-finished goods and material) can be executed. The linear equations may be solved by numeric algorithms. These numeric algorithms may be stored in a library 240 (e.g., International Mathematics and Statistics Library—IMSL) as will be discussed in more detail below.

In one embodiment, the model is a cost management model. The cost management model may use the same variables as discussed above with respect to the FIG. 2a embodiment. Furthermore, the linear equation system for the cost management scenario may be established using the same equations as described above for the FIG. 2a embodiment. As such, cost management may be formalized as a single application or process based on a unified data model similar to the FIG. 2a embodiment.

In the present example, the goal is to derive a single equation that operates on a database. As a result, the problem may be solved in a single process or equation instead of by several sequential steps as is performed in convention systems. The model including queries (e.g., how input screens on a user interface appear) and parameterizations of the planning functions are stored to the memory 233 in the calculation engine 236.

The cost estimate framework 232 extracts data for processing and provides the trigger to perform the processing. The cost estimate framework 232 further reads data from the transactional and plan data storage 234 (storing input data) and presents this data to the product cost simulation UI 230. The data presented to the product cost simulation UI 230 may be overridden by a user by, for example, using a user interface provided by the product cost simulation UI 230.

The calculation, itself, is a planning function that is not executed on an application server, but is executed directly on the data in a data store (e.g., the memory 233). Accordingly, the cost estimate framework 232 pushes the planning function down to the memory 233 to be executed in the calculation engine 236 located in the memory 233. Because all the data needed to perform the calculation is stored in memory 233 and the planning functions are now pushed down into the memory 233, the network based calculation system 228 is able to perform the processing more efficiently and quickly.

The cost estimate framework 232 accesses planning functions (e.g., linear equations) via the calculation engine 226 and accesses the input data from the transactional and plan data storage 234. The cost estimate framework 232 calls the planning functions on the calculation engine 236 which executes the calculation in the library 240. In example embodiments, the library 240 solves the linear equations of the planning functions by applying algorithms with the given parameterization to solve the linear equations. The library 240 may be a published library that is available for public use. In one embodiment, the library 240 comprises the IMSL. Large systems of linear equations can be solved efficiently by applying these numerical algorithms. While the present embodiment shows the library 240 being located within the memory 233 and coupled to the calculation engine 236 via a low-level virtual machine (LLVM) 238, alternative embodiments may have the library 240 located outside of the memory 233 but coupled thereto.

The calculation engine 236 executes other planning functions such as, for example, copying or simple (non-linear) formula calculations. The results are then returned to the cost estimate framework 232 and may be stored in the memory 233 (e.g., the transactional and plan data storage 234). The results may also be displayed in the front end, for example, by the user interface provided by the product cost simulation UA 230 to the user.

The memory 233 comprises a complete in-memory database that comprises data (e.g., model/configuration data and transactional data) and algorithms (e.g., stored procedures). The cost estimate framework 232 represents the model/configuration data, while the transactional and plan data storage 234 provides the transactional data. The library 240 and the calculation engine 236 represent various algorithms which may be applied to the planning functions.

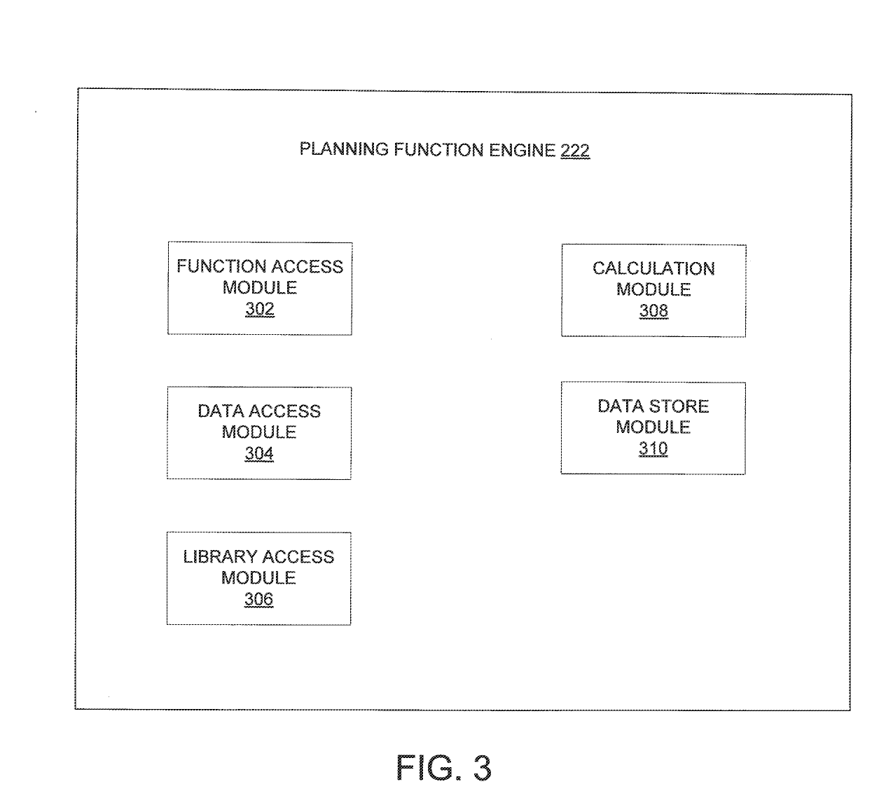

Referring now to FIG. 3, the planning function engine 222 of FIG. 2a is shown in more detail. The planning function engine 222 manages the processing in the memory 208. To this end, the planning function engine 222 comprises a function access module 302, a data access module 304, a library access module 306, a calculation module 308, and a data store module 310 communicatively coupled together. The function access module 302 receives the planning functions from the model data database 214 via the planning function controller 218. In example embodiments, the planning function controller 218 accesses and reads the planning functions from the model data database 214 and provides the planning functions to the function access module 302. The receipt of the planning functions may include receiving a trigger to perform processing in the memory 208.

Given the planning functions, the planning function engine 222 determines the data needed to perform the processing. Accordingly, the data access module 304 accesses and retrieves the extracted data (e.g., planning function parameterizations) stored in the plan data database 220 and any input data from the user (e.g., in the case of a simulation) via the analysis client 202. The library access module 306 provides the planning functions and the extracted data to the library 224 to execute the planning function calculation involving linear equations.

Similarly, the calculation module 308 forwards the data and planning functions to the calculation engine 226. The calculation engine 226 performs the corresponding calculations (e.g., non-linear calculations, copying) and the results are returned to the calculation module 308. Subsequently, the data store module 310 stores the results back to the plan data database 220. In some embodiments, the analysis client 202 accesses the results in the plan data database 220 and displays the results to the user.

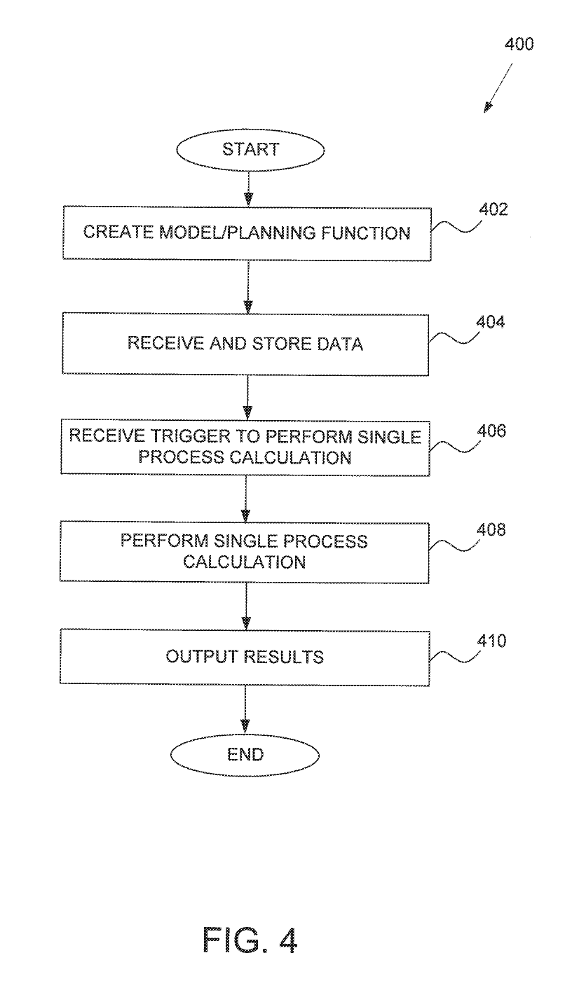

FIG. 4 is a flowchart of an example method 400 for providing a network based calculation system. The method 400 is described using the network based calculation system 106 of FIG. 2a. However, portions of the method 400 can equally be applicable to the network based calculation system 228 of FIG. 2b. In operation 402, a model comprising a planning function is created. In example embodiments, the planning modeler 212 creates the meta model. Additionally, the query designer 210 generates corresponding queries to extract the data that is needed for the planning function calculation. The queries may be subsequently sent to the business system 102 to obtain the data.

In operation 404, data is received from the business system 102 and stored to the plan data database 222. In some embodiments, the data from the business system 102 may be provided prior to the planning function calculations. For example, the data may be received at any time (e.g., during off-peak processing times) from the business system 102 using the queries generated and stored at the network based calculation system 106. In other embodiments, the data is provided when the planning function calculation is triggered. In these embodiments, the user may be providing hypothetical data via the analysis client 202 to the network based calculation system 106 to run simulations, for example.

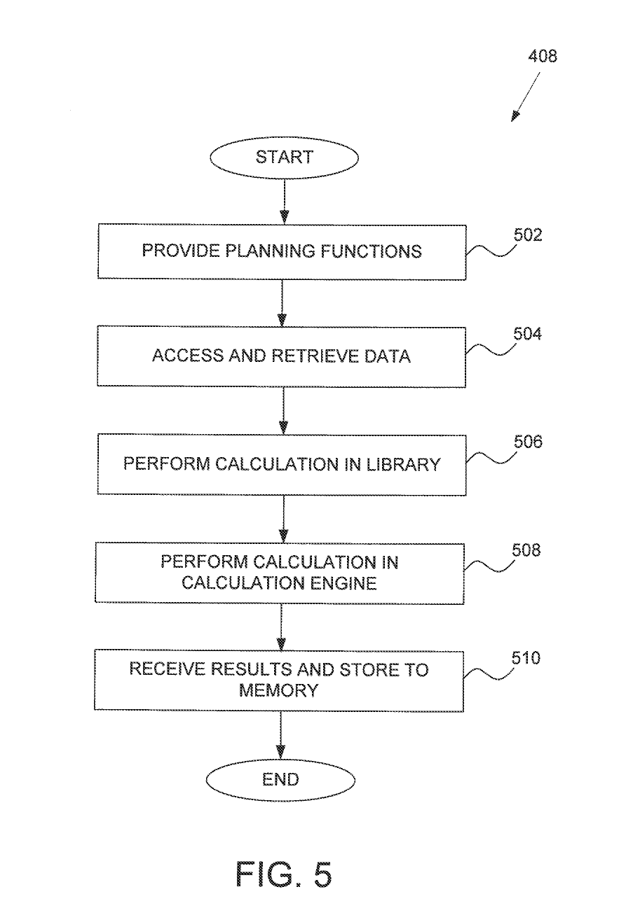

In operation 406, a trigger to perform the planning function calculation is received. In example embodiments, the planning function controller 218 receives the trigger. The trigger may be received from the business system 102 or directly via the analysis client 202. In response, the planning function calculation is performed in operation 408. Operation 408 will be discussed in more detail in connection with FIG. 5 below.

The results of the planning function calculations are output in operation 410. In example embodiments, the results are stored back into the memory 208 (e.g., into the plan data database 220) and the user may access the results therefrom (e.g., via the analysis client 202).

FIG. 5 is a flowchart of an example method (operation 408 of FIG. 4) for performing the planning function calculation using the network based calculation system 106 of FIG. 2a. However, portions of the method 408 can equally be applicable to the network based calculation system 228 of FIG. 2b. In example embodiments, the trigger received in operation 406 indicates the planning function (e.g., model or scenario) to be performed. As such in operation 502, the planning function is provided to the function access module 302 by the function access controller 218. The planning function controller 218 retrieves the planning function (e.g., including linear equation) pushes the planning functions (e.g., from the model data database 214) down to the memory 208 to be executed by the planning function engine 222. Because all the data needed to perform the calculation is stored in the memory 208 and the planning functions are now pushed down into the memory 208 for processing, the processing occurs in a more efficient and faster manner.

The data needed to perform the calculations are then received by the data access module 304 in operation 504. In example embodiments, the data access module 302 accesses and retrieves the extracted data stored in the plan data database 220 or input by the user via the analysis client 202. The planning function and data is provided to the library 224 which performs corresponding calculations (e.g., linear equations calculations) in operation 506. In example embodiments, the library 224 applies algorithms to the linear equation derived from the planning function.

Similarly, the data and planning function may be provided to the calculation engine 226 in operation 508. In example embodiments, the calculation module 308 of the planning function engine 222 forwards the data and planning function to the calculation engine 226, which then performs calculations or other functions (e.g., copying, simple formula calculations). It is noted that the data is sent to the library 224 and the calculation engine 226 depending on the kind of planning function involved. For example, any planning function that involves a linear equation may be sent to the library 224, while non-linear equations are sent to the calculation engine 226.

Once the planning function calculation(s) are completed by the library 224 or calculation engine 226, the results are returned to the calculation module 308 in operation 510. Subsequently, the data store module 310 stores the results back to the plan data database 220.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term “module” or “engine” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules, engines, or components are temporarily configured (e.g., programmed), each of the modules, engines, or components need not be configured or instantiated at any one instance in time. For example, where the modules, engines, or components comprise a general-purpose processor configured using software, the general-purpose processor may be configured as respective different modules at different times. Software may accordingly configure the processor to constitute a particular module or engine at one instance of time and to constitute a different module or engine at a different instance of time.

Modules or engines can provide information to, and receive information from, other modules or engines. Accordingly, the described modules and engines may be regarded as being communicatively coupled. Where multiples of such modules and engines exist contemporaneously, communications may be achieved through signal transmission (e.g., over appropriate circuits and buses) that connect the modules and engines. In embodiments in which multiple modules and engines are configured or instantiated at different times, communications between such modules and engines may be achieved, for example, through the storage and retrieval of information in memory structures to which the multiple modules or engines have access. For example, one module may perform an operation and store the output of that operation in a memory device to which it is communicatively coupled. A further module may then, at a later time, access the memory device to retrieve and process the stored output. Modules and engines may also initiate communications with input or output devices and can operate on a resource (e.g., a collection of information).

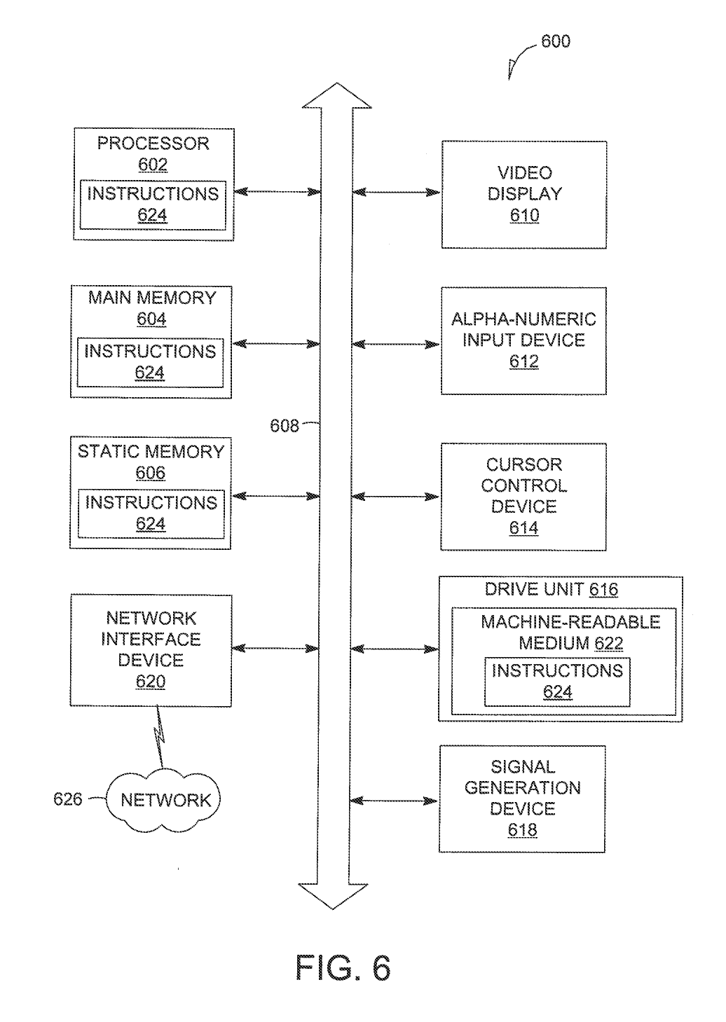

With reference to FIG. 6, an example embodiment extends to a machine in the example form of a computer system 600 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a settop box (STB), a Personal Digital Assistant (PDA), a cellular telephone, a web appliance, a network router, a switch or bridge, a server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 may include a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). In example embodiments, the computer system 600 also includes one or more of an alpha-numeric input device 612 (e.g., a keyboard), a user interface (UI) navigation device or cursor control device 614 (e.g., a mouse), a disk drive unit 616, a signal generation device 618 (e.g., a speaker), and a network interface device 620.

The disk drive unit 616 includes a machine-readable storage medium 622 on which is stored one or more sets of instructions 624 and data structures (e.g., software instructions) embodying or used by any one or more of the methodologies or functions described herein. The instructions 624 may also reside, completely or at least partially, within the main memory 604 or within the processor 602 during execution thereof by the computer system 600, the main memory 604 and the processor 602 also constituting machine-readable media. In some embodiments, the drive unit 616 is merely used for backup and security, while all data and processing instructions reside in the main memory 604.

While the machine-readable storage medium 622 is shown in an exemplary embodiment to be a single medium, the term “machine-readable storage medium” may include a single storage medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that causes the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories, optical and magnetic media, and non-transitory machine-readable storage media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 624 may further be transmitted or received over a communications network 626 using a transmission medium via the network interface device 620 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As used herein, the term “or” may be construed in either an inclusive or exclusive sense. Additionally, although various example embodiments discussed focus on a specific network-based environment, the embodiments are given merely for clarity in disclosure. Thus, any type of electronic system, including various system architectures, may employ various embodiments of the search system described herein and is considered as being within a scope of example embodiments.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving a trigger to perform a calculation based on an equation directed to a single process;
providing a planning function that models the single process to an engine within memory;
based on the planning function, retrieving data from within the memory that receives the planning function, the retrieved data to be used in the calculation;
based on the planning function, providing the planning function and retrieved data to a coupled library of algorithms in the memory; and
performing, using a processor of a machine, the calculation within the library in the memory using the planning function and the retrieved data.

2. The method of claim 1, further comprising storing a result of the calculation back into the memory.

3. The method of claim 1, further comprising receiving input from a user for use in the calculation, the input overwriting or replacing a portion of the retrieved data.

4. The method of claim 1, wherein the planning function comprises a single linear equation that models the single process.

5. The method of claim 1, further comprising providing a user interface for input of the data and for access to the data and results stored in the memory.

6. The method of claim 5, wherein the user interface allows for a group of users to collaboratively provide input for running a scenario.

7. The method of claim 1, further comprising providing the planning function and retrieved data to a calculation engine in the memory for performing a calculation or function not applicable to the library.

8. The method of claim 1, further comprising creating the planning function and corresponding queries for retrieval of the data.

9. The method of claim 1, wherein the single process comprises an end-to-end process that combines a plurality of applications.

10. The method of claim 1, wherein the performing the calculation within the library comprises solving a linear equation associated with the planning function.

11. A system comprising:
a processor of a machine;
means for receiving a trigger to perform a calculation based on an equation directed to a single process;
means for providing a planning function that models the single process to an engine within memory;
means for retrieving, based on the planning function, data from within the memory that receives the planning function, the retrieved data to be used in the calculation; and
a library configured to perform the calculation within the memory using the planning function and the retrieved data.

12. The system of claim 11, further comprising means for storing a result of the calculation back into the memory.

13. The system of claim 11, further comprising means for providing a user interface for input of the data and for access to the data and results stored in the memory.

14. The system of claim 11, wherein the library performs the calculation by solving a linear equation associated with the planning function.

15. A machine-readable storage medium in communication with at least one processor, the non-transitory machine-readable storage medium storing instructions which, when executed by the at least one processor of a machine, cause the machine to perform operations comprising:
receiving a trigger to perform a calculation based on an equation directed to a single process;
providing a planning function that models the single process to an engine within memory;
based on the planning function, retrieving data from within the memory that receives the planning function, the retrieved data to be used in the calculation;
based on the planning function, providing the planning function and retrieved data to a coupled library of algorithms in the memory; and
performing the calculation within the library in the memory using the planning function and the retrieved data.

16. The machine-readable storage medium of claim 15, wherein the operations further comprise storing a result of the calculation back into the memory.

17. The machine-readable storage medium of claim 15, wherein the operations further comprise receiving input from a user for use in the calculation, the input overwriting or replacing a portion of the retrieved data.

18. The machine-readable storage medium of claim 15, wherein the operations further comprise providing a user interface for input of the data and for access to the data and results stored in the memory, wherein the user interface allows for a group of users to collaboratively provide input for running a scenario.

19. The machine-readable storage medium of claim 15, wherein the performing the calculation within the library comprises solving a linear equation associated with the planning function.

20. The machine-readable storage medium of claim 15, wherein the operations further comprise creating the planning function and corresponding queries for retrieval of the data.
